(19) United States
(12) Patent Application Publication
(10) Pub. No.: US 2007/0267231 A1
(43) Pub. Date: Nov. 22, 2007

(54) Control device for a hybrid electric vehicle

(76) Inventor: Makoto Ogata, Kanagawa (JP)

Correspondence Address: JACOBSON HOLMAN PLLC, 400 SEVENTH STREET N.W., SUITE 600, WASHINGTON, DC, 20004, US

(21) Appl. No.: 11/716,691

(22) Filed: Mar. 12, 2007

(30) Foreign Application Priority Data
Mar. 10, 2006 (JP) 2006-65629

(51) Int. Cl. B60K 6/00

(52) U.S. Cl. 180/65.2; 903/904

(57) ABSTRACT

In a hybrid electric vehicle, an output shaft of an engine can be coupled with a rotary shaft of an electric motor of which a driving force can be transmitted to driving wheels. A power cut relay cuts off power supply from a power source to a starter motor through a starting switch when its contact is open. When the switch is shifted to a starting position, an ECU opens the contact of the relay and starts the engine by means of the electric motor, or starts the engine by means of the starter motor by closing the contact of the relay without starting the engine by means of the electric motor. If a specific failure is detected by a failure detection unit when the switch is shifted to the starting position, the ECU starts the engine by the starter motor without starting the engine by the electric motor.

### BACKGROUND OF THE INVENTION

1. Field of the Invention

The present invention relates to a control device for a hybrid electric vehicle, and more particularly, to a control device for a hybrid electric vehicle arranged such that a driving force of an electric motor can be transmitted to driving wheels of the vehicle and a rotary shaft of the electric motor can be mechanically coupled with an output shaft of an engine.

2. Description of the Related Art

Conventionally, a so-called parallel hybrid electric vehicle has been developed and put to practical use in which the respective driving forces of an engine and an electric motor can be transmitted to the driving wheels of the vehicle respectively.

In the hybrid electric vehicles of this type, the output shaft of the engine can be coupled with the rotary shaft of the electric motor, so that the engine can be started by utilizing the driving force of the electric motor that is operated as a motor.

One such hybrid electric vehicle that uses the driving force of the electric motor to start the engine is proposed in, for example, Unexamined Japanese Patent Publication No. 2000-154741 (hereinafter referred to as Patent Document 1).

In the hybrid electric vehicle described in Patent Document 1, the electric motor is used for cold start of the engine at low temperature that requires a relatively high cranking torque. If the cranking torque need not be very high, on the other hand, the engine is started by means of a starter motor that is provided separately from the electric motor.

Also, a hybrid electric vehicle in which the engine is started by utilizing the driving force of the electric motor is proposed in Unexamined Japanese Patent Publication No. 2005-155582 (hereinafter referred to as Patent Document 2).

In the hybrid electric vehicle described in Patent Document 2, the engine is started by the starter motor in case of a failure of a processing unit that executes a control for switching the engine start mode between starting by the electric motor and starting by the starter motor depending on the engine temperature or the like.

In the case where the engine start mode is switched and then the engine is started as described above, however, if the engine and the electric motor are simultaneously used, a pinion gear of the starter motor may be urged to engage the output shaft of the engine being rotated by the electric motor. If this is done, the pinion gear or a rotary mechanism of the starter motor may be broken, in some cases.

Thus, in starting the engine by means of the electric motor, it is necessary to avoid such breakage by preventing the starter motor from being actuated. In general, the starter motor is supplied with power through contacts of the starting switch. In the case where the electric motor is used to start the engine, therefore, the power supply to the starter motor is cut off by a power cut relay to prevent actuation of the starter motor.

If the power cut relay fails to operate normally, however, it cannot prevent the starter motor from being actuated when the engine is started by the electric motor in response to an operation of the starting switch. Consequently, the starter motor is driven by the electric motor when the engine is started by the electric motor and thereby the starter motor may be broken in the aforementioned manner.

### SUMMARY OF THE INVENTION

An aspect of the present invention is directed to a control device for a hybrid electric vehicle arranged such that a driving force of an electric motor can be transmitted to driving wheels and a rotary shaft of the electric motor can be mechanically coupled with an output shaft of an engine, comprising: a starter motor provided separately from the electric motor and configured to be able to transmit a driving force to the output shaft of the engine to thereby start the engine; a power source capable of supplying electric power to the starter motor; a starting switch adapted to allow power supply from the power source to the starter motor when shifted to a starting position and to cut off the power supply from the power source to the starter motor when not in the starting position; a power cut relay configured to cut off the power supply from the power source to the starter motor through the starting switch by opening a contact of the power cut relay; failure detection means for detecting a specific failure such that the power cut relay fails to cut off the power supply from the power source to the starter motor; and control means that opens the contact of the power cut relay and starts the engine by operating the electric motor as a motor in a case of starting the engine by means of the electric motor when the starting switch is shifted to the starting position, and on the other hand, starts the engine by closing the contact of the power cut relay to operate the starter motor without starting the engine by means of the electric motor in a case of starting the engine by means of the starter motor when the starting switch is shifted to the starting position, wherein the control means starts the engine by means of the starter motor without starting the engine by means of the electric motor if the specific failure is detected by the failure detection means when the starting switch is shifted to the starting position.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 shows a principal part of a hybrid electric vehicle having a control device according to one embodiment of the present invention;

FIG. 2 shows a starting control section provided in the hybrid electric vehicle of FIG. 1 and its peripheral circuit; and

FIG. 3 is a flowchart of starting control executed by the starting control section of FIG. 2.

### DETAILED DESCRIPTION OF THE INVENTION

An embodiment of the present invention will be hereinafter described with reference to the accompanying drawings.

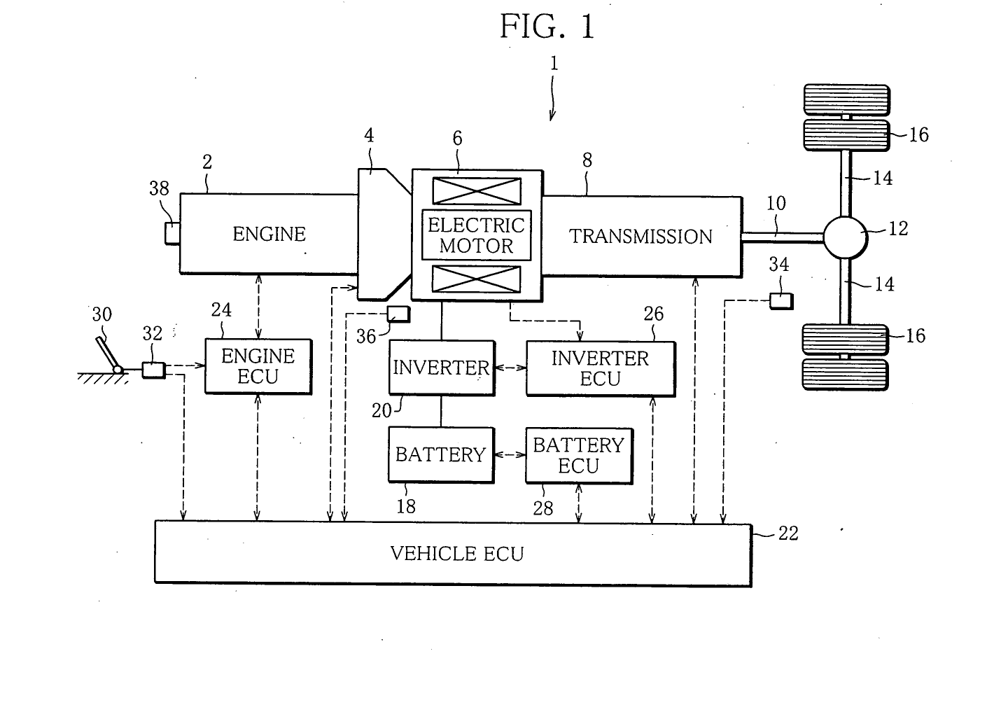

FIG. 1 shows a principal part of a hybrid electric vehicle 1 to which the present invention is applied. An input shaft of a clutch 4 is coupled to an output shaft of an engine 2, which is a diesel engine. An output shaft of the clutch 4 is coupled to an input shaft of an automatic transmission (hereinafter referred to as transmission) 8 through a rotary shaft of a permanent-magnetic synchronous motor (hereinafter referred to as electric motor) 6. An output shaft of the transmission 8 is connected to right and left driving wheels 16 through a propeller shaft 10, a differential device 12, and driving shafts 14.

When the clutch 4 is engaged, therefore, the output shaft of the engine 2 and the rotary shaft of the electric motor 6 are coupled together and can be mechanically connected to the driving wheels 16 through the transmission 8. On the other hand, when the clutch 4 is disengaged, the output shaft of the engine 2 is disconnected from the rotary shaft of the electric motor 6, and thus only the rotary shaft of the electric motor 6 can be mechanically connected to the driving wheels 16 through the transmission 8.

The electric motor 6 is operated as a motor when DC power stored in a battery 18 is supplied to the electric motor 6 after being converted into AC power by an inverter (power control means) 20. A driving torque of the electric motor 6 is transmitted to the driving wheels 16 after being shifted to a suitable speed by the transmission 8. When the vehicle is decelerating, the electric motor 6 is operated as a generator. Kinetic energy created by the rotation of the driving wheels 16 is transmitted to the electric motor 6 through the transmission 8 to be converted into AC power, thereby producing a regenerative braking torque. The AC power is then converted into DC power by the inverter 20 and charged to the battery 18. In this manner, the kinetic energy created by the rotation of the driving wheels 16 is recovered as electrical energy.

On the other hand, a driving torque of the engine 2 is transmitted to the transmission 8 through the rotary shaft of the electric motor 6 while the clutch 4 is engaged. After being shifted to a suitable speed, the driving torque of the engine 2 is transmitted to the driving wheels 16. Thus, if the electric motor 6 is operated as a motor while the driving torque of the engine 2 is transmitted to the driving wheels 16, both the driving torque of the engine and that of the electric motor 6 are transmitted to the driving wheels 16. In other words, a part of the driving torque to be transmitted to the driving wheels 16 to drive the vehicle is supplied by the engine 2, and at the same time, the rest of the driving torque is supplied by the electric motor 6.

If a storage rate (hereinafter referred to as SOC) of the battery 18 lowers so that the battery 18 needs to be charged, the electric motor 6 is operated as a generator. Moreover, the electric motor 6 is driven by using a part of the driving force of the engine 2, to thereby carry out power generation. AC power generated in this manner is converted into DC power by the inverter 20, and the battery 18 is charged with this DC power.

A vehicle ECU (control means) 22 implements engagement/disengagement control for the clutch 4 and the gear shift control of the transmission 8 in accordance with the operating states of the vehicle and the engine 2 as well as information supplied from an engine ECU 24, an inverter ECU 26, and a battery ECU 28, and the like. Further, the vehicle ECU 22 performs integrated control for properly controlling the engine 2 and the electric motor 6 in accordance with the state of the above-mentioned controls, and various kinds of operating conditions of the vehicle, such as starting, acceleration, and deceleration of the vehicle.

The engine ECU 24 carries out start/stop control of the engine 2 in accordance with information supplied from the vehicle ECU 22. Further, the engine ECU 24 carries out various kinds of controls required in the operation of the engine 2 per se, including idle control of the engine 2, regeneration control of an exhaust gas purification device (not shown), and the like. Furthermore, the engine ECU 24 controls the fuel injection quantity, injection timing, etc. of the engine 2 so that the engine 2 generates the torque required in the engine 2, which has been set by the vehicle ECU 22.

The inverter ECU 26 monitors the state of the inverter. 20 and sends information about the monitored state to the vehicle ECU 22. Also, the inverter ECU 26 controls the inverter 20 in accordance with the torque to be generated by the electric motor 6, which has been set by the vehicle ECU 22, and thereby controls the operation of the electric motor 6 so that the electric motor 6 is operated as a motor or a generator.

The battery ECU 28 detects the temperature and voltage of the battery 18, current flowing between the inverter 20 and the battery 18, etc. Further, the battery ECU 28 obtains the SOC of the battery 18 from these detection results, and sends the obtained SOC to the vehicle ECU 22 together with the detection results.

While exchanging information with the engine ECU 24, the inverter ECU 26, and the battery ECU 28, the vehicle ECU 22 instructs the engine ECU 24 and the inverter ECU 26 to appropriately control the engine 2 and the electric motor 6, respectively, and also suitably controls the clutch 4 and the transmission 8.

When performing such control actions, the vehicle ECU 22 calculates a required torque necessary to run the vehicle, based on detection results provided by an accelerator position sensor 32 for detecting the depression amount of an accelerator pedal 30, a vehicle speed sensor 34 for detecting the traveling speed of the vehicle, and a revolution speed sensor 36 for detecting the revolution speed of the electric motor 6. Then, based on the information from the individual ECUs, the vehicle ECU 22 allots the required torque to the engine 2 and the electric motor 6 in accordance with the current operating states of the vehicle, the engine 2, and the electric motor 6, and notifies the engine ECU 24 and the inverter ECU 26 of the respective allotted torques. At this time, the vehicle ECU 22 controls the transmission 8 and the clutch 4 as needed.

Where the required torque is allotted to the electric motor 6 only and no torque is allotted to the engine 2, the vehicle ECU 22 disengages the clutch 4 and instructs the inverter ECU 26 to set the output torque of the electric motor 6 to the required torque.

In this case, since no torque is allotted to the engine 2, the engine ECU 24 allows the engine 2 to idle. On the other hand, the inverter ECU 26 controls the inverter 20 in accordance with the torque instructed from the vehicle ECU 22, so that the DC power of the battery 18 is converted into AC power by the inverter 20 and supplied to the electric motor 6. The electric motor 6. The electric motor 6 is thus supplied with the AC power and is operated as a motor to output the required torque. The output torque of the electric motor 6 is transmitted to the driving wheels 16 through the transmission 8.

Where the required torque is allotted to both the engine 2 and the electric motor 6, moreover, the vehicle ECU 22 engages the clutch 4. Then, the vehicle ECU 22 instructs the engine ECU 24 to set the output torque of the engine 2 to its corresponding allotted torque, and also instructs the inverter ECU 26 to set the output torque of the electric motor 6 to its corresponding allotted torque.

The engine ECU 24 controls the engine 2 so that the allotted torque instructed from the vehicle ECU22 may be outputted from the engine 2. The inverter ECU 26 controls the inverter 20 in accordance with the allotted torque instructed from the vehicle ECU 22. As a result, the required torque, which is the sum of the output torque of the engine 2 and the output torque of the electric motor 6, is transmitted to the driving wheels 16 through the transmission 8.

Where the required torque is allotted to the engine 2 alone and no torque is allotted to the electric motor 6, the vehicle ECU 22 engages the clutch 4. Then, the vehicle ECU 22 instructs the engine ECU 24 to set the output torque of the engine 2 to the required torque, and at the same time, instructs the inverter ECU 26 to set the output torque of the electric motor 6 to zero.

The engine ECU 24 controls the engine 2 so that the required torque instructed from the vehicle ECU 22 may be outputted from the engine 2. On the other hand, the inverter ECU 26 controls the inverter 20 so that the electric motor 6 is operated as neither a motor nor a generator. As a result, the required torque outputted from the engine 2 is transmitted to the driving wheels 16 through the transmission 8.

Since the rotary shaft of the electric motor 6 can be coupled with the output shaft of the engine 2 through the clutch 4, the engine 2 can be started by operating the electric motor 6 as a motor. However, a starter motor 38 is provided separately from the electric motor 6 in consideration of a case where the electric motor 6 fails to output a necessary torque for starting the engine 2 due to lowering of the SOC of the battery 18 or the like.

The starter motor 38 is similar to an engine starter motor used in an ordinary vehicle of which the sole driving power source is the engine, and therefore, a detailed description thereof is omitted. The starter motor 38 comprises a pinion gear (not shown) capable of releasably engaging a ring gear (not shown) that is attached to an end portion of the output shaft of the engine 2. The starter motor 38 is configured to start the engine 2 by driving the output shaft of the engine 2 by means of the pinion gear that is in mesh with the ring gear.

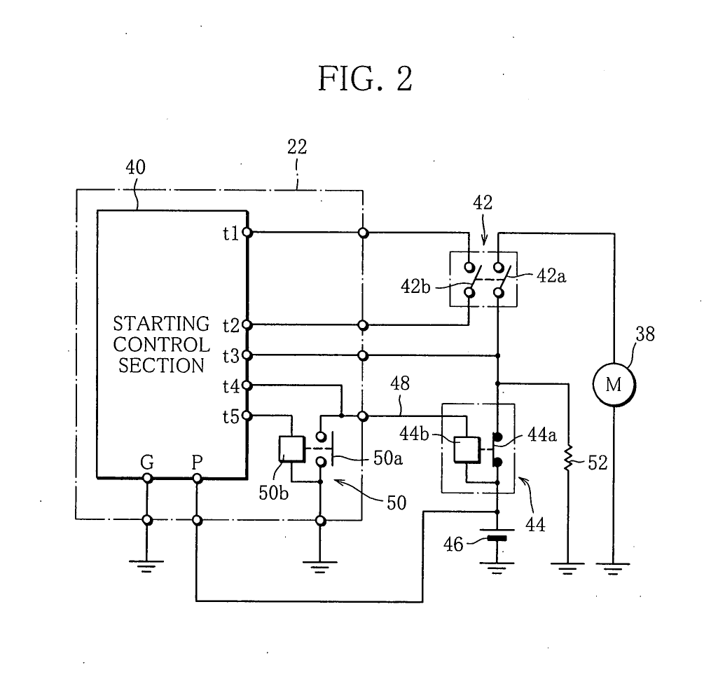

The vehicle ECU 22 properly switches the way of starting the engine 2 between starting by the starter motor 38 and starting by the electric motor 6. The vehicle ECU 22 has a starting control section 40 for controlling the starter motor 38 in this process. FIG. 2 shows a configuration of a control circuit for the starter motor 38 including the starting control section 40.

As shown in FIG. 2, the starter motor 38 is supplied with electric power from a power source battery (power source) 46 through a first contact 42a of a starting switch 42 and a contact 44a of a power cut relay 44. The power source battery 46 supplies power not only to the starter motor 38 but also to various devices and sensors, including the vehicle ECU 22, inverter ECU 26, and battery ECU 28, which are used for the operation control of the engine 2, clutch 4, and transmission 8.

The starting switch 42 can be shifted between three positions, which are an OFF-position, ON-position, and STRAT-position. The OFF-position is a position for cutting off the power supply from the power source battery 46 to the ECUs, devices, and sensors and for stopping the engine 2. The ON-position is a position for allowing the power supply, and the STRAT-position (starting position) is a position for starting the engine 2. The starting switch 42 automatically returns to the ON-position if an operator releases it after shifting it from the ON-position to the STRAT-position. When the starting switch 42 is in the ON-position or the OFF-position, the first contact 42a of the starting switch 42 is open. When the switch 42 is in the STRAT-position, the contact 42a is closed.

The contact 44a of the power cut relay 44 is a normally-closed contact, which opens when a solenoid coil 44b is energized to be excited. The solenoid coil 44b of the relay 44 is connected to the vehicle ECU 22 by a signal line 48 and grounded through a contact 50a of a control relay 50 in the vehicle ECU 22. The contact 50a of the control relay 50 is a normally-open contact, which is closed when a solenoid coil 50b that is connected to a terminal t5 of the starting control section 40 is energized to be excited.

If the solenoid coil 50b of the control relay 50 is energized by the starting control section 40, the contact 50a is closed, and thereby the solenoid coil 44b of the power cut relay 44 is energized to open the contact 44a.

Further, a junction between the signal line 48 and the contact 50a of the control relay 50 diverges in the vehicle ECU 22 to be connected to a terminal t4 of the starting control section 40. The starting control section 40 detects disconnection of the signal line 48 by monitoring voltage at the terminal t4.

Specifically, the voltage (hereinafter referred to as supply voltage) of the power source battery 46 is applied to the terminal t4 through the solenoid coil 44b of the power cut relay 44 when the contact 50a of the control relay 50 is open. If the supply voltage is not applied to the terminal t4 notwithstanding that the contact 50a of the control relay 50 is open, that is, notwithstanding that the solenoid coil 50b of the control relay 50 is not energized, the starting control section 40 (failure detection means) determines that the signal line 48 is broken. If the signal line 48 is broken in this manner, the solenoid coil 44b of the power cut relay 44 cannot be energized and the contact 44a can not be opened. Consequently, when the first contact 42a of the starting switch 42 is closed, the power supply from the power source battery 46 to the starter motor 38 can not be cut off.

When the contact 50a of the control relay 50 is closed, the terminal t4 is grounded through the contact 50a, so that the voltage at the terminal t4 is 0 V. If the voltage at the terminal t4 is not 0 V notwithstanding that the contact 50a of the control relay 50 is closed, that it, notwithstanding that the solenoid coil 50b of the control relay 50 is energized, the starting control section 40 determines that there is an abnormality at the contact 50a or on the ground side of the contact 50a. Also in this case, since no signal can be correctly sent to the signal line 48, the starting control section 40 (failure detection means) determines that there is a failure with respect to the signal line 48. Even in case of such a failure, the solenoid coil 44b of the power cut relay 44 cannot be energized, so that the contact 44a cannot be opened. Thus, the power supply from the power source battery 46 to the starter motor 38 cannot be cut off when the first contact 42a of the starting switch 42 is closed.

A junction between the first contact 42a of the starting switch 42 and the contact 44a of the power cut relay 44 is grounded through a detection resistor 52 for detecting the operating state of the contact 44a and connected to a terminal t3 of the starting control section 40. The detection resistor 52 has a resistance value such that an infinitesimal current flows when the contact 44a of the power cut relay 44 is closed and the supply voltage is applied to the detection resistor 52. Thus, voltage applied to the terminal t3 is the supply voltage when the contact 44a is closed and becomes 0 V when the contact 44a is open.

If the voltage at the terminal t3 is the supply voltage notwithstanding that the solenoid coil 44b of the power cut relay 44 is energized, the starting control section 40 (failure detection means) determines that the contact 44a of the power cut relay 44 is fixedly closed. Also if the contact 44a is fixedly closed, the power supply from the power source battery 46 to the starter motor 38 can not be cut off when the first contact 42a of the starting switch 42 is closed.

Further, if the voltage at the terminal t3 is 0 V notwithstanding that the solenoid coil 44b of the power cut relay 44 is not energized, the starting control section 40 determines that the contact 44a of the power cut relay 44 is fixedly open.

The starting switch 42 has a second contact 42b that operates in the same manner as the first contact 42a. The opposite ends of the second contact 42b are connected individually to terminals t1 and t2 of the starting control section 40 so that the starting section 40 can detect the operating state of the starting switch 42.

Furthermore, the starting control section 40 has a ground terminal G and a power terminal P to which the power source battery 46 is connected. These terminals are used to feed power into the starting control section 40.

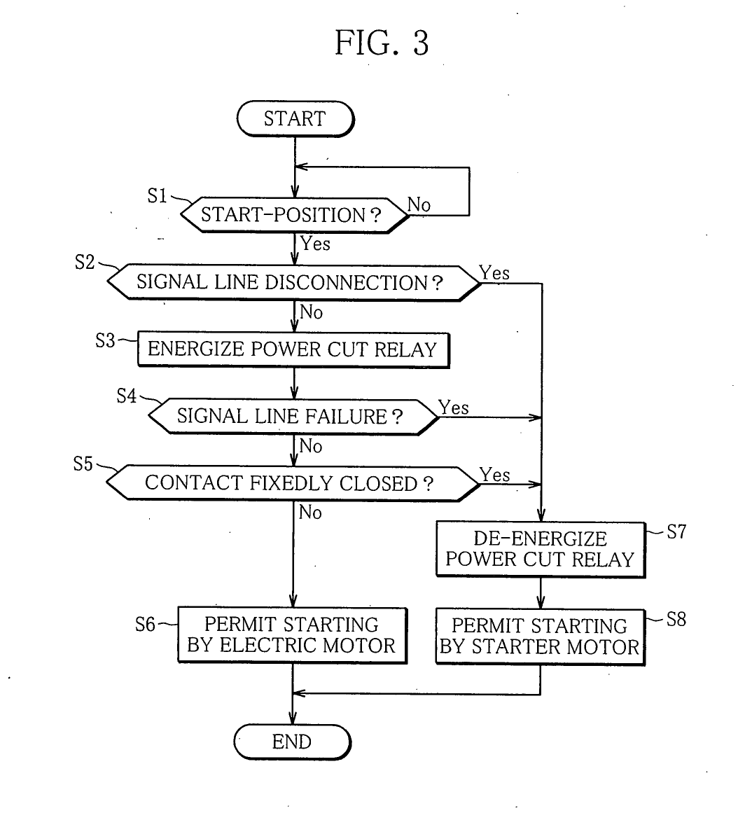

With use of the control circuit for the starter motor 38 constructed in this manner, the starting control section 40 performs starting control according to the flowchart of FIG. 3. When the starting switch 42 is shifted from the OFF-position to the ON-position, the starting control section 40 starts the starting control.

When the starting control is started, the starting control section 40 first determines in Step S1 whether or not the starting switch 42 is in the STRAT-position. If the starting switch 42 is not in the STRAT-position, the starting control section 40 repeats the process of Step S1 so that the starting control section 40 puts itself into a standby state for the starting control. If the starting switch 42 is shifted to the STRAT-position, the starting control section 40 determines in Step S2 whether or not the signal line 48 is broken, based on the voltage at the terminal t4.

At this time, the starting control section does not energize the solenoid coil 50b of the control relay 50. If the supply voltage is not applied to the terminal t4 in spite of that, the starting control section 40 determines that the signal line 48 is broken.

If the starting control section 40 determines in Step S2 that the signal line 48 is not broken, the starting control section 40 advances the process to Step S3. In Step S3, the starting control section 40 energizes the solenoid coil 50b of the control relay 50 to close the contact 50a, thereby energizing the solenoid coil 44b of the power cut relay 44 to open the contact 44a.

Next, in Step S4, the starting control section 40 determines, based on the voltage at the terminal t4, whether or not there is a failure with respect to the signal line 48. In this case, the solenoid coil 50b of the control relay 50 is energized. If the voltage at the terminal t4 is not 0 V in spite of that, the starting control section 40 determines that there is an abnormality at the contact 50a or on the ground side of the contact 50a and therefore determines that there is a failure with respect to the signal line 48.

If the starting control section 40 determines in Step S4 that there is no failure with respect to the signal line 48, the starting control section 40 advances the process to Step S5. In Step S5, the starting control section 40 determines, based on the voltage at the terminal t3, whether or not the contact 44a of the power cut relay 44 is fixedly closed.

At this time, the solenoid coil 44b of the power cut relay 44 is energized. If the voltage at the terminal t3 is the supply voltage in spite of that, the starting control section 40 determines that the contact 44a of the power cut relay 44 is fixedly closed.

If the starting control section 40 determines in Step S5 that the contact 50a of the control relay 50 is not fixedly closed, the starter motor 38 is never actuated, because the power supply from the power source battery 46 to the starter motor 38 through the first contact 42a the starting switch 42 is cut off. Thereupon, the starting control section 40 permits starting the engine 2 by the electric motor 6. In response to this, the vehicle ECU 22 confirms that the transmission 8 is in its neutral position such that the electric motor 6 is mechanically disconnected from the driving wheels 16 and that the clutch 4 is engaged. Then the vehicle ECU 22 indicates to the inverter ECU 26 an output torque of the electric motor 6 necessary for starting the engine 2. Further, the vehicle ECU 22 instructs the engine ECU 24 to operate the engine 2.

Based on the indication from the vehicle ECU 22, the inverter ECU 26 operates the electric motor 6 as a motor to generate the output torque indicated by the vehicle ECU 22, thereby cranking the engine 2. As this is done, the engine ECU 24 starts fuel supply to the engine 2 and the engine 2 starts up, whereupon the starting control terminates.

On the other hand, if the starting control section 40 determines in Step S2 that the signal line 48 is broken in the aforesaid manner, the starting control section 40 advances the process to Step S7. In Step S7, the control section 40 de-energizes the solenoid coil 50b of the control relay 50 to open the contact 50a, thereby de-energizing the solenoid coil 44b of the power cut relay 44. In Step S8, moreover, the starting control section 40 permits starting by the starter motor 38.

Since the signal line 48 is broken in this case, the solenoid coil 44b of the power cut relay 44 is de-energized without opening the contact 50a of the control relay 50. However, the starting control section 40 opens the contact 50a in order to securely de-energize the solenoid coil 44b of the relay 44 even if the connection of the signal line 48 is temporarily restored when the signal line 48 is incompletely broken.

The contact 44a is securely closed because the solenoid coil 44b of the power cut relay 44 is de-energized in this manner. When the first contact 42a of the starting switch 42 is then closed, electric power is supplied from the power source battery 46 to the starter motor 38. Thereupon, the pinion gear of the starter motor 38 engages the ring gear, so that the driving force of the starter motor 38 is transmitted to the output shaft of the engine 2.

As this is done, the vehicle ECU 22 receives the permission for starting the engine 2 by the starter motor 38 from the starting control section 40, and disengages the clutch 4 to mechanically disconnect the output shaft of the engine 2 from the rotary shaft of the electric motor 6. Furthermore, the vehicle ECU 22 instructs the engine ECU 24 to operate the engine 2.

Upon receipt of the instruction from the vehicle ECU 22, the engine ECU 24 starts fuel supply to the engine 2 and the engine 2 starts up, whereupon the starting control terminates.

If the starting control section 40 determines in Step S4 that there is a failure with respect to the signal line 48 in the aforesaid manner, the starting control section 40 also advances the process to Step S7. In Step S7, the control section 40 de-energizes the solenoid coil 50b of the control relay 50 to open the contact 50a, thereby de-energizing the solenoid coil 44b of the power cut relay 44. In Step S8, moreover, the starting control section 40 permits starting the engine 2 by the starter motor 38.

Since there is a failure with respect to the signal line 48 in this case, the solenoid coil 44b of the power cut relay 44 is de-energized without opening the contact 50a of the control relay 50. However, the starting control section 40 opens the contact 50a in order to securely de-energize the solenoid coil 44b of the relay 44 even if the connection with regard to the signal line 48 is temporarily restored when the failure with regard to the signal line 48 is incomplete.

Then, the engine 2 is started in the aforementioned manner in Steps S7 and S8. The driving force of the starter motor 38 is transmitted to the output shaft of the engine 2 and the engine 2 starts up, whereupon the starting control terminates.

If the starting control section 40 determines in Step S5 that the contact 44a of the power cut relay 44 is fixedly closed in the aforesaid manner, the starting control section 40 also advances the process to Step S7. In Step S7, the control section 40 de-energizes the solenoid coil 50b of the control relay 50 to open the contact 50a, thereby de-energizing the solenoid coil 44b of the power cut relay 44. In Step S8, moreover, the starting control section 40 permits starting the engine 2 by the starter motor 38.

The contact 44a of the power cut relay 44 is fixedly closed in this case. However, the starting control section 40 securely keeps the contact 44a closed by de-energizing the solenoid coil 44b in Step S7 in consideration of a case where the fixedly closed state is dissolved from some cause.

Then, the engine 2 is started in the aforementioned manner in Steps S7 and S8. The driving force of the starter motor 38 is transmitted to the output shaft of the engine 2 and the engine 2 starts up, whereupon the starting control terminates.

As mentioned before, the starting control section 40 detects the fixedly open state of the contact 44a of the power cut relay 44 based on the voltage at the terminal t3. If the contact 44a is fixedly open, the results of the determinations in any of Steps S2, S4 and S5 are negative (“NO”), so that the starting control section 40 permits starting the engine 2 by the electric motor 6. Thus, the engine 2 is started in the aforementioned manner by the electric motor 6 which is operated as a motor.

More specifically, when the contact 44a of the power cut relay 44 is fixedly open, electric power cannot be supplied from the power source battery 46 to the starter motor 38 even if the first contact 42a of the starting switch 42 is closed. Accordingly, the engine 2 cannot be started by the starter motor 38, and the starting control section 40 executes starting control such that the engine 2 can be securely started by the electric motor 6.

Since the contact 44a of the power cut relay 44 is fixedly open in this case, the solenoid coil 44b need not be energized. In consideration of a case where the fixedly open state is dissolved from some cause, however, the starting control section 40 energizes the solenoid coil 44b in Step S3, and the vehicle ECU 22 causes only the electric motor 6 to start the engine 2 securely.

When starting the engine 2 with the starting switch 42 in the STRAT-position, as described above, in the case where there is a failure with respect to the signal line 48, such as a disconnection of the signal line 48 between the start control section 40 and the power cut relay 44 or an abnormality at the contact 50a of the control relay 50 or on the ground side of the contact 50a, and in the case where the contact 44a of the power cut relay 44 is fixedly closed, the starting control section 40 accurately detects these situation as a trouble such that the power supply from the power source battery 46 to the starter motor 38 cannot be cut off by the power cut relay 44.

If such a trouble occurs, the vehicle ECU 22 causes the starter motor 38 to start the engine 2 without starting the engine 2 by the electric motor 6. Accordingly, it is possible to prevent the occurrence of a problem that the power supply from the power source battery 46 to the starter motor 38 fails to be cut off so that the engine 2 is started by both the electric motor 6 and the starter motor 38 at a time, possibly breaking the motor 38.

If the contact 44a of the power cut relay 44 is fixedly opened, the power supply from the power source battery 46 to the starter motor 38 through the first contact 42a of the starting switch 42 is cut off due to the fixedly open state of the contact 44a, and therefore the starter motor 38 cannot be actuated. In the starting control, the engine 2 is started by the electric motor 6 in such a situation, so that the engine 2 can be started securely.

Although the control device for the hybrid electric vehicle according to one embodiment of the present invention has been described, the present invention is not limited to the foregoing embodiment alone.

In the embodiment described above, for example, the hybrid electric vehicle is configured so that the electric motor 6 is arranged between the clutch 4 and the transmission 8. However, the arrangement of electric motor 6 is not limited to this, but the hybrid electric vehicle may alternatively be configured so that the electric motor 6 is arranged between the engine 2 and the clutch 4, for example.

Although a diesel engine is used as the engine 2 in the foregoing embodiment, the type of the engine is not limited to this, but a gasoline engine may alternatively be used for the purpose.

Although a permanent-magnetic synchronous motor is used as the electric motor 6 in the foregoing embodiment, furthermore, the type of the electric motor is not limited to this either.

Further, the power cut relay 44 used in the foregoing embodiment is designed so that the contact 44a is opened when the solenoid coil 44b is energized. Alternatively, however, a relay designed so that the contact 44a is closed when the solenoid coil 44b is energized may be used as the power cut relay 44. In this case, the power cut relay 44 is controlled so that the contact 44a is opened/closed in the same manner as in the foregoing embodiment.

Furthermore, the control relay 50 used in the foregoing embodiment is designed so that the contact 50a is closed when the solenoid coil 50b is energized. Alternatively, however, a relay designed so that the contact 50a is opened when the solenoid coil 50b is energized may be used as the control relay 50. In this case, the control relay 50 is controlled so that the contact 50a is opened/closed in the same manner as in the foregoing embodiment.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A control device for a hybrid electric vehicle arranged such that a driving force of an electric motor can be transmitted to driving wheels and a rotary shaft of the electric motor can be mechanically coupled with an output shaft of an engine, comprising:
a starter motor provided separately from the electric motor and configured to be able to transmit a driving force to the output shaft of the engine to thereby start the engine;
a power source capable of supplying electric power to the starter motor;
a starting switch adapted to allow power supply from the power source to the starter motor when shifted to a starting position and to cut off the power supply from the power source to the starter motor when not in the starting position;
a power cut relay configured to cut off the power supply from the power source to the starter motor through the starting switch by opening a contact of the power cut relay;
failure detection means for detecting a specific failure such that the power cut relay fails to cut off the power supply from the power source to the starter motor; and
control means that opens the contact of the power cut relay and starts the engine by operating the electric motor as a motor in a case of starting the engine by means of the electric motor when the starting switch is shifted to the starting position, and on the other hand, starts the engine by closing the contact of the power cut relay to operate the starter motor without starting the engine by means of the electric motor in a case of starting the engine by means of the starter motor when the starting switch is shifted to the starting position, wherein
the control means starts the engine by means of the starter motor without starting the engine by means of the electric motor if the specific failure is detected by the failure detection means when the starting switch is shifted to the starting position.

2. The control device for a hybrid electric vehicle according to claim 1, wherein
the control means controls an open-close operation of the contact of the power cut relay through a signal line connected between the power cut relay and the control means; and
the failure detection means detects a disconnection of the signal line as the specific failure.

3. The control device for a hybrid electric vehicle according to claim 1, wherein
the failure detection means detects a fixedly closed state of the contact of the power cut relay as the specific failure.

4. The control device for a hybrid electric vehicle according to claim 3, wherein
the control means starts the engine by means of the electric motor when the contact of the power cut relay is fixedly opened.
